(19) United States
(12) Patent Application Publication
(10) Pub. No.: US 2023/0153682 A1
(43) Pub. Date: May 18, 2023

(54) POLICY ESTIMATION METHOD, POLICY ESTIMATION APPARATUS AND PROGRAM

(71) Applicant: NIPPON TELEGRAPH AND TELEPHONE CORPORATION, Tokyo (JP)

(72) Inventors: Masahiro KOJIMA, Tokyo (JP); Masami TAKAHASHI, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/797,678

(22) PCT Filed: Feb. 6, 2020
(86) PCT No.: PCT/JP2020/004533

§ 371 Date: Aug. 4, 2022

(51) Int. Cl. G06N 20/00

(52) U.S. Cl. CPC G06N 20/00

(57) ABSTRACT

A value function and a policy of entropy-regularized reinforcement learning in a case where a state transition function and a reward function vary with time can be estimated by causing a computer to perform an input procedure in which a state transition probability and a reward function that vary with time are input and an estimation procedure in which an optimal value function and an optimal policy of entropy-regularized reinforcement learning are estimated by a backward induction algorithm based on the state transition probability and the reward function.

### TECHNICAL FIELD

The present invention relates to a policy estimation method, a policy estimation apparatus, and a program.

### BACKGROUND ART

Among AI techniques attracting attention in recent years, a method called reinforcement learning (RL), which employs a framework in which a learner (agent) learns a behavior (policy) through interaction with an environment, has yielded significant results in the field of game AI in computer games, Go, or the like (NPL 2 and NPL 3).

An objective of common reinforcement learning is that the agent obtains an action rule (policy) that maximizes the sum of (discounted) rewards obtained from the environment. However, in recent years, studies have been actively conducted on a method called entropy-regularized RL in which, not only rewards but, the (discounted) sum of a reward and policy entropy is maximized. In entropy regularized RL, the closer to random the policy is, the larger the value of a term regarding policy entropy in an objective function becomes. Therefore, it is confirmed that entropy regularized RL is effective in obtaining a policy that provides better search results more easily, etc. (NPL 1).

Conventionally, the entropy-regularized RL is mainly applied to robot control or the like, that is, the application target has been the learning of a policy in a time-homogeneous Markov decision process, in which a state transition function and a reward function do not vary depending on time. The use of the time-homogeneous Markov decision process is deemed to be a reasonable assumption when a robot arm control (in a closed environment) or the like is considered.

### CITATION LIST

### Non Patent Literature

[NPL 1] Tuomas Haarnoja, Haoran Tang, Pieter Abbeel, and Sergey Levine. Reinforcement learning with deep energy-based policies. In Proceedings of the 34th International Conference on Machine Learning-Volume 70, pages 1352-1361. JMLR. org, 2017.
[NPL 2] Volodymyr Mnih, Koray Kavukcuoglu, David Silver, Andrei A. Rusu, Joel Veness, Marc G. Bellemare, Alex Graves, Martin Riedmiller, Andreas K. Fidjeland, Georg Ostrovski, Stig Petersen, Charles Beattie, Amir Sadik, Ioannis Antonoglou, Helen King, Dharshan Kumaran, Daan Wierstra, Shane Legg, and Demis Hassabis. Human-level control through deep reinforcement learning. Nature, 518(7540):529-533, 2015.
[NPL 3] David Silver, Aja Huang, Chris J. Maddison, Arthur Guez, Laurent Sifre, George vanden Driessche, Julian Schrittwieser, Ioannis Antonoglou, Veda Panneershelvam, Marc Lanctot, Sander Dieleman, Dominik Grewe, John Nham, Nal Kalchbrenner, Ilya Sutskever, Timothy Lillicrap, Madeleine Leach, Koray Kavukcuoglu, Thore Graepel, and Demis Hassabis. Mastering the game of go with deep neural networks and tree search. Nature, 529:484-489, 2016.

### SUMMARY OF THE INVENTION

### Technical Problem

However, when a system that intervenes in a person is constructed in the healthcare field, etc. by using reinforcement learning, it cannot be said that an approach using the time-homogeneous Markov decision process is appropriate.

A specific example will be discussed. In this example, construction of a healthcare application that helps users to have healthy living will be described. In this case, the application corresponds to an agent, and a user using the application corresponds to an environment. An activity being performed by the user such as “housework” or “work” corresponds to a state, and intervention of the application in the user, for example, a notification content to the user such as “Why don't you go to work?” or “Why don't you take a break?” corresponds to an action. A state transition probability corresponds to a probability that an activity currently being performed by the user transitions to an activity performed at the next time due to the intervention of the application. For example, exercise time per day or closeness to target sleeping time (predetermined by the user) is set as a reward.

In such an example, regarding the state transition probability of the user, since an action performed after a state of “taking a bath” is deemed to vary depending on time, for example, in the morning and in the evening, the assumption that a state transition function does not vary in terms of time is considered inappropriate.

With the foregoing in view, it is an object of the present invention to enable estimation of a value function and a policy of entropy-regularized reinforcement learning in a case where a state transition function and a reward function vary with time.

### Means for Solving the Problem

To solve the above problem, a computer performs an input procedure in which a state transition probability and a reward function that vary with time are input and an estimation procedure in which an optimal value function and an optimal policy of entropy-regularized reinforcement learning are estimated by a backward induction algorithm based on the state transition probability and the reward function.

### Effects of the Invention

A value function and a policy of entropy-regularized reinforcement learning in a case where a state transition function and a reward function vary with time can be estimated.

### BRIEF DESCRIPTION OF DRAWINGS

FIG. 1 illustrates an example of a hardware configuration of a policy estimation apparatus 10 according to an embodiment of the present invention.

FIG. 2 illustrates an example of a functional configuration of the policy estimation apparatus 10 according to the embodiment of the present invention.

FIG. 3 is a flowchart for describing an example of a processing procedure performed by the policy estimation apparatus 10 upon learning parameters.

FIG. 4 is a flowchart for describing an example of a processing procedure for estimating a value function and a policy.

### DESCRIPTION OF EMBODIMENTS

[Markov Decision Process (MDP)]

In this section, an outline of reinforcement learning will be described. Reinforcement learning refers to a method in which a learner (agent) estimates an optimal action rule (policy) through interaction with an environment. In reinforcement learning, a Markov decision process (MDP) (“Martin L. Puterman, Markov decision processes: Discrete stochastic dynamic programming, 2005”) is often used for setting the environment, and in the present embodiment as well, an MDP is used.

A commonly-used time-homogeneous Markov decision process is defined by a 4-tuple (S, A, P, R). S is called state space, and A is called action space. Respective elements, seS and aeA, are called states and actions, respectively. P:S×A×S→[0,1] is called a state transition probability and determines a state transition probability that an action a performed in a state s leads to a next state s′. R:S×A→R′ is a reward function. R′ represents a set of all real numbers. The reward function defines a reward obtained when the action a is performed in the state s. The agent performs the action such that the sum of rewards obtained in the future in the above environment is maximized. The determined probability that the agent selects the action a to perform in each state s is called a policy n:S×A→[0,1].

In the above time-homogeneous Markov decision process, it is assumed that the state transition probability and the reward function have the same settings at every time point t. In contrast, in the time-inhomogeneous Markov decision process discussed in the present embodiment, the state transition probability and the reward function are allowed to have different settings at an individual time point t, which is defined as P={Pₜ}ₜ, R={Rₜ}ₜ. However, note that Pₜ:S×A×S→[0, 1], Rₜ:S×A→R′. In the following description, the settings of the time-inhomogeneous Markov decision process will be used.

[Policy]

Once one policy π={πₜ}ₜ, πₜ:S×A→[0,1] at an individual time point is defined for the agent, the agent can perform interaction with the environment. At each time t, the agent in a state sₜ determines an action aₜ in accordance with a policy πₜ(⋅|sₜ). Next, in accordance with the state transition probability and the reward function, a state sₜ₊₁ to Pₜ(⋅|sₜ,aₜ) of the agent and a reward rₜ=Rₜ(sₜ,aₜ) at the next time are determined. By repeating this determination, a history of the states and actions of the agent is obtained. Hereinafter, the history of the states and actions (s₀, a₀, s₁, a₁, . . . , s_{T}) obtained by repeating the transition T times from time 0 is denoted as h_{T}, which is called an episode.

[Outline of Present Embodiment]

Hereinafter, an outline of the present embodiment will be described.

[Entropy-Regularized Reinforcement Learning in Finite Time-Inhomogeneous Markov Decision Process]

In the method of the present embodiment, a state transition probability (that temporally varies (that varies with time)) and a reward function (that temporally varies) are input, and an optimal policy is output. In the present embodiment, by using the formulation of the entropy-regularized RL (reinforcement learning), an optimal policy π* is defined as a policy that maximizes an expected value of the sum of a reward and policy entropy.

$$\begin{matrix}[ Math . 1 ] & \\ \\ π = \begin{matrix}argmax \\ π\end{matrix} {𝔼}_{{h}_{T}}^{π} [ {\sum }_{t = 0}^{T - 1} \{ ℛ ( {s}_{t} , {a}_{t} , {s}_{{t}_{`}} ) + a ℋ ( {π}_{t} ( \cdot \vert {s}_{t} ) ) \} ] & ( 1 )\end{matrix}$$

However, E^{π}_{hT}[ ] represents an average operation (expected value) related to the output of an episode h_{T} by the policy π. H(π(⋅|sₖ)) is entropy of a probability distribution {π(k|sₜ)}ₖ, and α is a hyperparameter that controls a weight of an entropy term. Since the entropy term takes a large value if the policy distribution is close to a uniform distribution, the entropy term becomes larger if the policy is a stochastic policy, which is not a decisive policy that always selects a fixed action. Thus, the optimal policy can be expected to be a stochastic policy that can obtain more rewards. This property enables the policy that allows more exploratory actions to be obtained more easily, and in the example case of the healthcare application described above, the stochastic behavior enables intervention that does not easily bore the user. In addition, by setting α=0, the entropy-regularized RL serves the same as a common RL.

An action-value function (a function (hereinafter, referred to as an “action-value function”) that formulates the value of taking the action a in the state s under the policy n of the entropy-regularized RL in the finite time-inhomogeneous Markov decision process is defined by the following mathematical formula.

$${Q}_{t}^{π} ( s , a ) = {𝔼}_{{h}_{T}}^{π} [ {{\sum }^{T - 1}}_{{t}^{′} = t} \{ {ℛ}_{t} ( {s}_{{t}^{′}} , {a}_{{t}^{′}} , {s}_{{t}^{′} + 1} ) + αℋ ( {π}_{{t}^{′}} ( \cdot \vert {s}_{{t}^{′}} ) ) \} \vert {s}_{0} = s , {a}_{0} = a ] \qquad [ Math . 2 ]$$

When the policy is an optimal policy, this action-value function satisfies the following optimal Bellman equation (of the entropy-regularized RL in the finite time-inhomogeneous Markov decision process).

[Math. 3]

Qₜ^{π*}(s,a)= [symbol] _{s′˜P}_{ₜ}_{(s′|s,a)[R}_{ₜ}_{(s,a,s′)}+Vₜ₊₁^{π*}(s′)] (2)

where Vₜ^{π*}(s)=α log Σ_{a′} exp(α⁻¹Qₜ^{π*}(s,a′)) (3)

Note that V^{π}ₜ(s) is a function (hereinafter, referred to as a “state-value function”) for formulating the value of the state s under the policy π

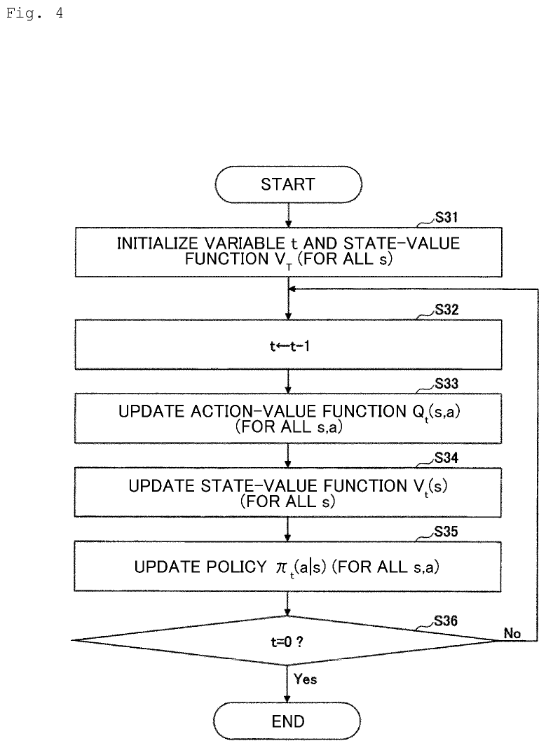

Thus, an optimal policy and an optimal value function (an optimal action-value function, an optimal state-value function) can be calculated by a backward induction algorithm (FIG. 4). The optimal policy is expressed by the following mathematical formula using the optimal value function.

[Math. 4]

πₜ*(a|s)=exp(α⁻¹{Qₜ^{π*}(s,a)−Vₜ^{π*}(s)}) (4)

### [Policy Estimation Apparatus 10]

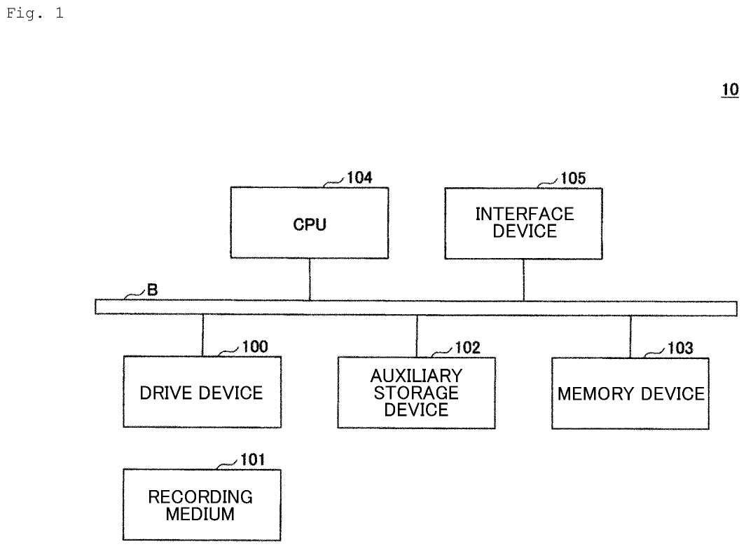

Hereinafter, the policy estimation apparatus 10 that is a computer implementing the above will be described. FIG. 1 illustrates an example of a hardware configuration of the policy estimation apparatus 10 according to the embodiment of the present invention. The policy estimation apparatus 10 in FIG. 1 includes a drive device 100, an auxiliary storage device 102, a memory device 103, a CPU 104, an interface device 105, etc. connected with each other by a bus B.

A program that implements processing performed by the policy estimation apparatus 10 is provided by a recording medium 101 such as a CD-ROM. When the recording medium 101 storing the program is set in the drive device 100, the program is installed from the recording medium 101 to the auxiliary storage device 102 via the drive device 100. The program does not necessarily need to be installed from the recording medium 101 but may be downloaded from another computer via a network. The auxiliary storage device 102 stores the installed program as well as necessary files, data, or the like.

In response to an instruction for starting the program, the memory device 103 reads the program from the auxiliary storage device 102 and stores the read program therein. The CPU 104 executes functions of the policy estimation apparatus 10 in accordance with the program stored in the memory device 103. The interface device 105 is used as an interface for connecting to the network.

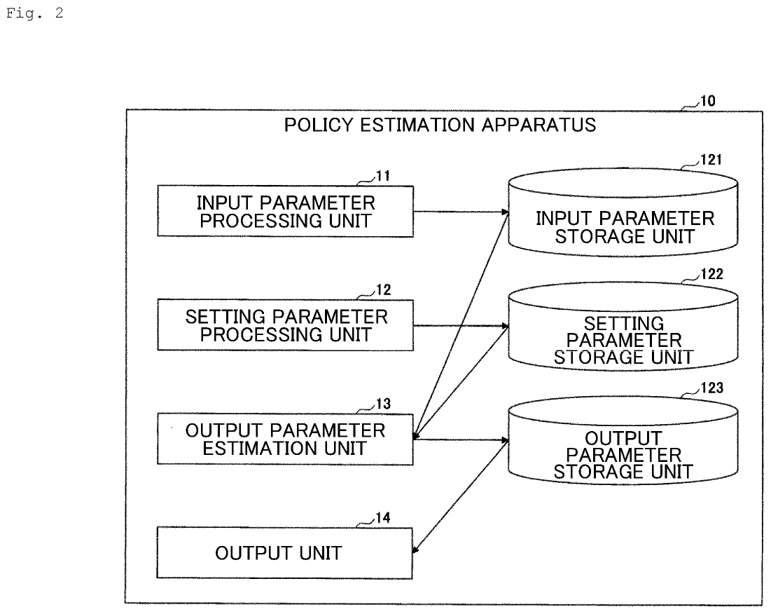

FIG. 2 illustrates an example of a functional configuration of the policy estimation apparatus 10 according to the embodiment of the present invention. In FIG. 2, the policy estimation apparatus 10 includes an input parameter processing unit 11, a setting parameter processing unit 12, an output parameter estimation unit 13, an output unit 14, etc. Each unit is implemented by at least one program installed in the policy estimation apparatus 10 causing the CPU 104 to perform the processing. The policy estimation apparatus 10 also uses the input parameter storage unit 121, a setting parameter storage unit 122, an output parameter storage unit 123, etc. Each of these storage units can be implemented by using a storage or the like that can be connected to the memory device 103, the auxiliary storage device 102, or the policy estimation apparatus 10 via the network.

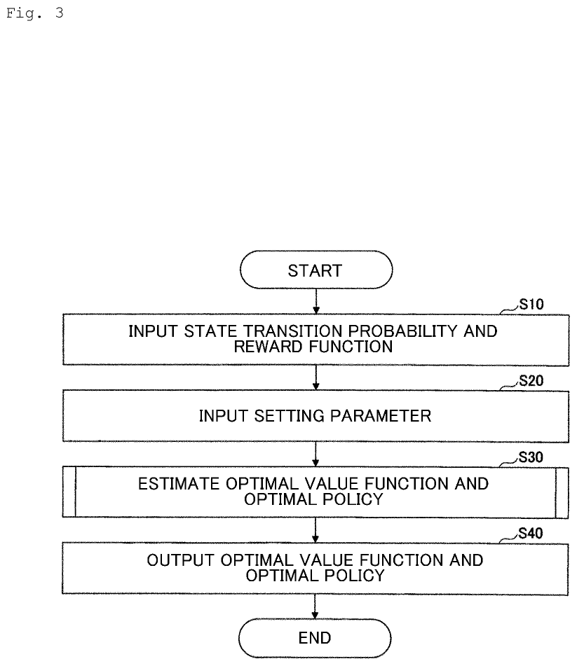

FIG. 3 is a flowchart for describing an example of a processing procedure performed by the policy estimation apparatus 10 upon learning parameters.

In step S10, the input parameter processing unit 11 receives a state transition probability P={Pₜ}ₜ and a reward function R={Rₜ}ₜ as inputs and records the state transition probability P and the reward function R in the input parameter storage unit 121. That is, in the present embodiment, the state transition probability P and the reward function R are estimated in advance, and a known state is assumed. The state transition probability P and the reward function R may be input by the user by using an input device such as a keyboard or may be acquired by the input parameter processing unit 11 from the storage device where the state transition probability P and the reward function R are stored in advance.

Next, the setting parameter processing unit 12 receives a setting parameter such as a hyperparameter as an input and records the setting parameter in the setting parameter storage unit 122 (S20). The setting parameter may be input by the user by using the input device such as a keyboard or may be acquired by the setting parameter processing unit 12 from the storage device where the setting parameter is stored in advance. For example, the value of a or the like used in the mathematical formulas (3) and (4) is input.

Next, the output parameter estimation unit 13 receives the state transition probability and the reward function recorded in the input parameter storage unit 121 and the setting parameter recorded in the setting parameter storage unit 122 as inputs, estimates (calculates) an optimal value function (Q*ₜ and V*ₜ) and an optimal policy π* by the backward induction algorithm, and records the parameters corresponding to the estimation results in the output parameter storage unit 123 (S30).

Next, the output unit 14 outputs the optimal value function (Q*ₜ and V*ₜ) and the optimal policy π* recorded in the output parameter storage unit 123 (S40).

Next, step S30 will be described in detail. FIG. 4 is a flowchart for describing an example of a processing procedure for estimating a value function and a policy.

In step S31, the output parameter estimation unit 13 initializes a variable t and a state-value function V_{T}. Specifically, the output parameter estimation unit 13 substitutes T for the variable t and substitutes 0 for a state-value function V_{T(s)} for all states s. The variable t indicates an individual time point. T is the number of elements of the state transition probability P and the reward function R (that is, the number of the state transition probabilities that vary at each time t or the number of the reward functions that vary at each time t) input in step S10 in FIG. 3. “All states s” refer to all the states s included in the state transition probability P, and the same applies to the following description.

Next, the output parameter estimation unit 13 updates the value of the variable t (S32). Specifically, the output parameter estimation unit 13 substitutes a value obtained by subtracting 1 from the variable t for the variable t.

Next, the output parameter estimation unit 13 updates an action-value function Qₜ(s,a) for every combination of all states s and all actions a, based on the above mathematical formula (2) (S33). “All actions a” refer to all the actions a included in the state transition probability P input in step S10, and the same applies to the following description.

Next, the output parameter estimation unit 13 updates a state-value function Vₜ(s) for all states s, based on the above mathematical formula (3) (S34). In step S34, the action-value function Qₜ(s,a) updated (calculated) in previous step S33 is substituted into the mathematical formula (3).

Next, the output parameter estimation unit 13 updates a policy πₜ (a|s) for every combination of all states sand all actions a, based on the above mathematical formula (4) (S35). In step S35, the action-value function Qₜ(s,a) updated (calculated) in previous step S33 and Vₜ(s) updated (calculated) in previous step S34 are substituted into the mathematical formula (4).

Next, the output parameter estimation unit 13 determines whether or not the value of t is 0 (S36). If the value of t is larger than 0 (No in S36), the output parameter estimation unit 13 repeats step S32 and onward. If the value of t is 0 (Yes in S36), the output parameter estimation unit 13 ends the processing procedure in FIG. 4. That is, the Qₜ(s,a), Vₜ(s), and nₜ(a|s) at this point are estimated as the optimal action-value function, the optimal state-value function, and the optimal policy, respectively.

As described above, according to the present embodiment, the value function and the policy can be estimated in the entropy-regularized RL in the time-inhomogeneous Markov decision process in which the state transition function and the reward function vary with time.

As a result, according to the present embodiment, for example, even in the case where the assumption that the state transition probability and the reward function have the same settings at every time point is not satisfied, for example, when the above-described healthcare application for helping users to have healthy living is constructed, the optimal value function and the optimal policy can be estimated.

In the present embodiment, the input parameter processing unit 11 is an example of an input unit. The output parameter estimation unit 13 is an example of an estimation unit.

While the embodiment of the present invention has thus been described, the present invention is not limited to the specific embodiment, and various modifications and changes can be made within the gist of the present invention described in the scope of claims.

### REFERENCE SIGNS LIST

10 Policy estimation apparatus
11 Input parameter processing unit
12 Setting parameter processing unit
13 Output parameter estimation unit
14 Output unit
100 Drive device
101 Recording medium
102 Auxiliary storage device
103 Memory device
104 CPU
105 Interface device
121 Input parameter storage unit
122 Setting parameter storage unit
123 Output parameter storage unit
B Bus

1. A computer implemented method for estimating a policy associated with a machine learning, comprising:
receiving as input a state transition probability and a reward function that vary with time;
estimating, based on the state transition probability and the reward function, an optimal value function and an optimal policy of entropy-regularized reinforcement learning using a backward induction algorithm; and
performing, based on the estimated optimal policy, a machine learning, wherein the learnt machine determines an action in an environment.

2. The computer implemented method according to claim 1, wherein the estimating further comprises estimating the optimal policy such that an expected value of a sum of a reward and policy entropy is maximized.

3. A policy estimation apparatus comprising a processor configured to execute a method comprising:
receiving as input a state transition probability and a reward function that vary with time;
estimating, based on the state transition probability and the reward function, an optimal value function and an optimal policy of entropy-regularized reinforcement learning using a backward induction algorithm; and
performing, based on the estimated optimal policy, a machine learning, wherein the learnt machine determines an action in an environment.

4. The policy estimation apparatus according to claim 3, wherein
the estimating further comprises estimating the optimal policy such that an expected value of a sum of a reward and policy entropy is maximized.

5. A computer-readable non-transitory recording medium storing computer-executable program instructions that when executed by a processor cause a computer to execute a method comprising:
receiving as input a state transition probability and a reward function that vary with time;
estimating, based on the state transition probability and the reward function, an optimal value function and an optimal policy of entropy-regularized reinforcement learning using a backward induction algorithm; and
performing, based on the estimated optimal policy, a machine learning, wherein the learnt machine determines an action in an environment.

6. The computer implemented method according to claim 1, wherein the machine learning is associated with a healthcare application, and the optimal policy includes an action in an environment for maintaining a health.

7. The computer implemented method according to claim 1, wherein the machine learning includes the entropy-regularized reinforcement learning.

8. The computer implemented method according to claim 1, wherein the estimating is based on a time-inhomogeneous Markov decision process.

9. The policy estimation apparatus according to claim 3, wherein the machine learning is associated with a healthcare application, and the optimal policy includes an action in an environment for maintaining a health.

10. The policy estimation apparatus according to claim 3, wherein the machine learning includes the entropy-regularized reinforcement learning.

11. The policy estimation apparatus according to claim 3, wherein the estimating is based on a time-inhomogeneous Markov decision process.

12. The computer-readable non-transitory recording medium according to claim 5, wherein the estimating further comprises estimating the optimal policy such that an expected value of a sum of a reward and policy entropy is maximized.

13. The computer-readable non-transitory recording medium according to claim 5, wherein the machine learning is associated with a healthcare application, and the optimal policy includes an action in an environment for maintaining a health.

14. The computer-readable non-transitory recording medium according to claim 5, wherein the machine learning includes the entropy-regularized reinforcement learning.

15. The computer-readable non-transitory recording medium according to claim 5, wherein the estimating is based on a time-inhomogeneous Markov decision process.
